(19) United States
(12) Patent Application Publication
(10) Pub. No.: US 2016/0072216 A1
(43) Pub. Date: Mar. 10, 2016

(54) Connector retention mechanism with connection for sacrificial portion

(71) Applicant: TMB, Inc., San Fernando, CA (US)

(72) Inventors: Ainārs Pastars, Riga (MC); Colin Waters, San Fernando, CA (US)

(21) Appl. No.: 14/478,393

(22) Filed: Sep. 5, 2014

(51) Int. Cl. H01R 13/518; H01R 13/62; H01R 43/20

(52) U.S. Cl. CPC H01R 13/518; H01R 43/20; H01R 13/62

(57) ABSTRACT

Assembly with integrated connector savers. The connector savers are connected to an indented subassembly board, that is connected directly to a circuit board. The other side of the connector savers are at precisely the right level to be connected to from the exterior surface of the chassis. A retention plate holds the connection savers in place, at exactly the right height, but also allows the connector savers to be easily removed and replaced

### BACKGROUND

Today's video systems often use connectors that are inserted and removed. In order to the usable in the portable industry of a commercial video environment, a connector must be capable of being readily connected and disconnected many different times to be truly useful.

Some connectors, however, are rated to only have a rated number of cycles of matings and dematings. Equipment gets disconnected and connected every time it is used in a commercial video operation. For a connector such as a DVI connector, which may only be rated for 50 insertions and removals, frequent connections will damage the connector. Since the connectors are permanently connected to the unit itself, for example hardwired directly to a circuit board, the replacement of those parts can be costly and difficult.

DVI “savers” use a plug that has DVI connectors at both ends, where one end connects to the unit, the other to the connector. The DVI savers are sacrificial: when the connector on the saver unit fails, the unit as a whole can be removed and replaced.

### SUMMARY

The present application describes an assembly that is sized to hold connector savers. The connector savers are retained by a plate that keeps them from falling off. The main connectors are recessed into the chassis so that the connector of the connector saver is extended to the outside level of the perimeter of the chassis.

### BRIEF DESCRIPTION OF THE DRAWINGS

in the drawings:

FIG. 1 shows a top view of the chassis with connectors indented connector savers according to an embodiment;

FIG. 2 shows an exploded view of the connector savers and the covering plate;

FIG. 3 shows a rear view of the assembly with the plate connected; and

FIG. 4 shows a close-up connector with the connector plate openings.

### DETAILED DESCRIPTION

The inventor recognized a number of issues with DVI savers. First of all, since the DVI savers often hang off the back of the unit, they may look unsightly, and worse, may actually stress the connector as they put additional torque on the connector portion that the connector portion was not designed to take. In addition, they extend outside the perimeter of the unit, and may take up more space and may even prevent the unit from fitting properly into a racking system or transportation case.

The embodiments address these and other issues.

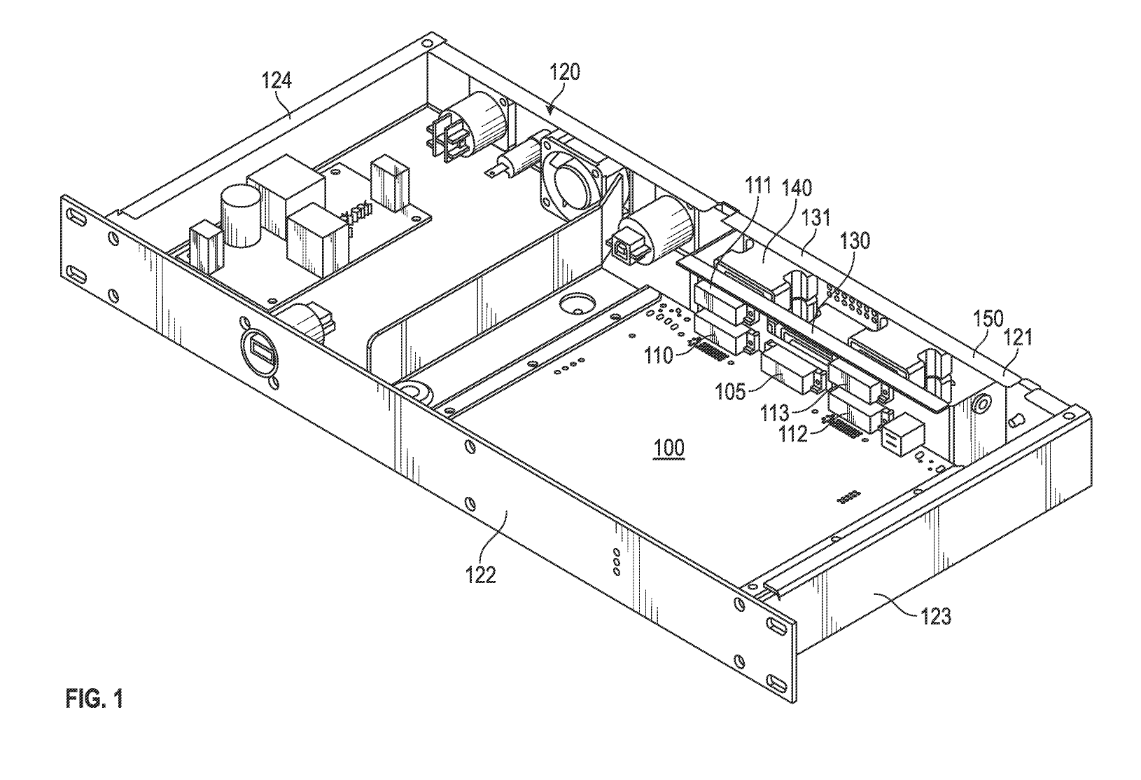

FIG. 1 shows a top view of the embodiments. In the FIG. 1 view, the device is configured as being a DVI splitter. The DVI splitter may be part of a video device, such as a media player and/or media server, but the techniques described herein can be used in other units. The device is shown without the top cover. However, any device which uses any kind of connector which can wear out or may need replacement can be used according to embodiments.

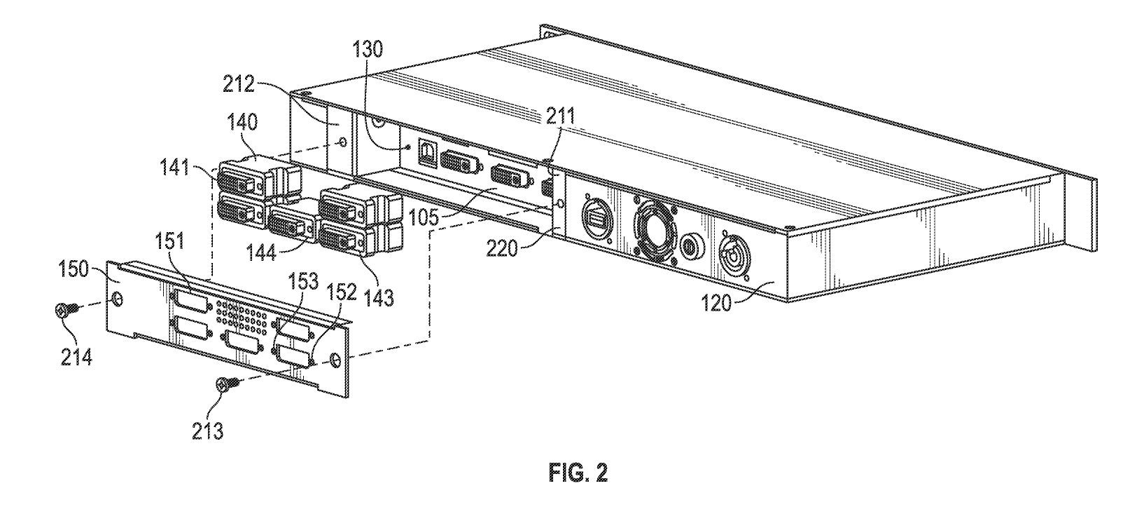

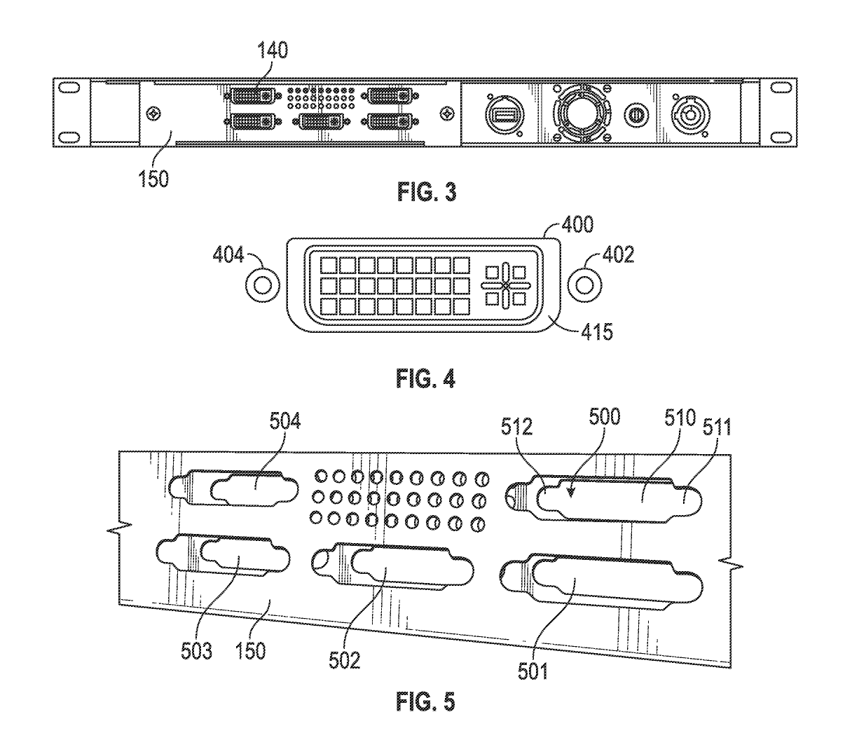

The embodiment described herein describes using a DVI connector. The device includes an internal circuit board 100, connected to an input DVI connector 105. FIG. 2 shows the assembled device, showing the connectors from the outside of the device, and showing the other side of connector 105. Connector 105 is connected to the circuit board, which can carry out the DVI splitting function to create multiple outputs at multiple different DVI connectors 110, 111, 112 and 113.

Each of the connectors 105, 110, 111, 112 and 113 are connected to the circuit board and thus would be extremely inconvenient to replace. In the embodiment, the perimeter of the chassis 120 is formed by a back plate 121, a front plate 122, and side plates 123 and 124. As conventional, the front and back plates 121, 122 are substantially flat. However, a sub chassis 130 is formed indented from the connector portion 131 of the chassis. FIG. 2 shows how the connector portion 130 is indented relative to the remaining portion 120 of the back portion.

Each connector of the connector portion includes a DVI saver connected thereto shown generally as 140. The DVI saver has DVI connectors at each end acting as a DVI coupler. One end of the DVI saver 140 is connected to a corresponding connector on the indented sub chassis 130. The other end of the DVI saver forms the output connector. The output connector is held in place by a retention plate 150 that is shown in FIG. 2. The retention plate 150 includes cutout portions 151 that are matched in size to the area of the protrusion 141 from the DVI saver 140.

In addition, the DVI savers include screw portions 143, 144 into which the DVI connector from the cable can be connected. The cutouts 151 may also include cutouts such as 152, 153 through which the screw portions extend. All of these surfaces, and also the rear surface of the sub chassis 130, thus further hold the DVI coupler in place. All of these things can hold the DVI savers in place and prevent them from falling out or moving based on connector forces or on forces from the cables. In addition, when looking at the device from the rear with a retention plate installed, one cannot actually tell that these are DVI savers because the rear of the device has a consistent flat plate holding in the DVI savers.

In one embodiment, the connector itself shown as 410 may fit loosely into the hole, thus leaving room for the connector outer metal portion to extend slightly below the surface of the connector plate 150. However, the screw portions 400 402 may fit more tightly, since those screw portions are intended in any case to be structural.

In operation, DVI savers 140 are each screwed into the respective connectors 105 on the subchassis 130, which is held below the surface 120. Once in place, the retention plate 150 is mounted around each of the output connectors 141 of each of the DVI savers, and the retention plate is then mounted to mounting surfaces 211, 212 of the rear surface 120. The retention plate includes outer edges that are slightly wider than the width of the indented portion and attach to a slightly recessed area 220 which is recessed by the thickness of the retention plate 150. This forms a completely flat surface on the back of the chassis. Respective screws 213, 214 hold the retention plate in place. This plate stops the DVI savers from falling off or being lost. However, it is a simple matter, when the connector wears out, to replace the DVI saver with a new DVI saver.

However, the user does not necessarily know that there are DVI savers, because the user sees the back panel shown in FIG. 4, where all the connectors are the normal height with no extending connector parts from the DVI saver, and all held into place by the retention plate 150.

A detailed view of the retention plate 150 is shown in FIG. 5, that shows 5 different connector holes, 500, 501, 502, 503 and 504. Each of these connector holes forms an area for a connector saver of the type described herein. The connector holes in this embodiment include a first connector area 510 and second areas 511, 512 to hold the retaining screws and nuts.

Although only a few embodiments have been disclosed in detail above, other embodiments are possible and the inventors intend these to be encompassed within this specification. The specification describes certain technological solutions to solve the technical problems that are described expressly and inherently in this application. This disclosure describes embodiments, and the claims are intended to cover any modification or alternative or generalization of these embodiments which might be predictable to a person having ordinary skill in the art. For example, other connectors other than DVI connectors can be used. Moreover, any connector coupler can be used behind the plate of any sort. In one embodiment, the screws 213 and 214 can be knurled screws of a type intended to unscrew with a user's finger.

Those of skill would further appreciate that this system can be used with various illustrative logical blocks, modules, circuits, and algorithm steps described in connection with the embodiments disclosed herein may be implemented as electronic hardware, computer software running on a specific purpose machine that is programmed to carry out the operations described in this application, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments.

The various illustrative logical blocks, modules, and circuits described in connection with the embodiments disclosed herein, may be implemented or performed with a general or specific purpose processor, or with hardware that carries out these functions, e.g., a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. The processor can be part of a computer system that also has an internal bus connecting to cards or other hardware, running based on a system BIOS or equivalent that contains startup and boot software, system memory which provides temporary storage for an operating system, drivers for the hardware and for application programs, disk interface which provides an interface between internal storage device(s) and the other hardware, an external peripheral controller which interfaces to external devices such as a backup storage device, and a network that connects to a hard wired network cable such as Ethernet or may be a wireless connection such as a RF link running under a wireless protocol such as 802.11. Likewise, external bus 18 may be any of but not limited to hard wired external busses such as IEEE-1394 or USB. The computer system can also have a user interface port that communicates with a user interface, and which receives commands entered by a user, and a video output that produces its output via any kind of video output format, e.g., VGA, DVI, HDMI, displayport, or any other form. This may include laptop or desktop computers, and may also include portable computers, including cell phones, tablets such as the IPAD™ and Android platform tablet, and all other kinds of computers and computing platforms.

A processor may also be implemented as a combination of computing devices, e.g., a combination of a DSP and a microprocessor, a plurality of microprocessors, one or more microprocessors in conjunction with a DSP core, or any other such configuration. These devices may also be used to select values for devices as described herein.

The steps of a method or algorithm described in connection with the embodiments disclosed herein may be embodied directly in hardware, in a software module executed by a processor, using cloud computing, or in combinations. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of tangible storage medium that stores tangible, non transitory computer based instructions. An exemplary storage medium is coupled to the processor such that the processor can read information from, and write information to, the storage medium. In the alternative, the storage medium may be integral to the processor. The processor and the storage medium may reside in reconfigurable logic of any type.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer.

The memory storage can also be rotating magnetic hard disk drives, optical disk drives, or flash memory based storage drives or other such solid state, magnetic, or optical storage devices. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media. The computer readable media can be an article comprising a machine-readable non-transitory tangible medium embodying information indicative of instructions that when performed by one or more machines result in computer implemented operations comprising the actions described throughout this specification.

Operations as described herein can be carried out on or over a website. The website can be operated on a server computer, or operated locally, e.g., by being downloaded to the client computer, or operated via a server farm. The website can be accessed over a mobile phone or a PDA, or on any other client. The website can use HTML code in any form, e.g., MHTML, or XML, and via any form such as cascading style sheets (“CSS”) or other.

The computers described herein may be any kind of computer, either general purpose, or some specific purpose computer such as a workstation. The programs may be written in C, or Java, Brew or any other programming language. The programs may be resident on a storage medium, e.g., magnetic or optical, e.g. the computer hard drive, a removable disk or media such as a memory stick or SD media, or other removable medium. The programs may also be run over a network, for example, with a server or other machine sending signals to the local machine, which allows the local machine to carry out the operations described herein.

Also, the inventor(s) intend that only those claims which use the words “means for” are intended to be interpreted under 35 USC 112, sixth paragraph. Moreover, no limitations from the specification are intended to be read into any claims, unless those limitations are expressly included in the claims.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A system, comprising:
a chassis, forming a box with an outer perimeter, having a first surface defining a straight outer edge, and an indented portion which is indented relative to the outer edge,
at least one connector, mounted on said indented portion;
a connector coupler, connected to said at least one connector, said connector coupler having a first end connected to said at least one connector, and having a second end extending in an opposite direction from said first end;
a retention plate, formed of a flat surface, with at least one opening in said flat surface which opening is shaped to surround an outer surface of said second end of said connector coupler and said retention plate having surfaces that hold said connector coupler within said at least one opening, said retention plate connected to said first surface of said chassis and sitting at a location that forms a flat surface relative to said first surface.

2. The system as in claim 1, wherein said chassis is substantially rectangular in perimeter, and said indented portion is located along a rear of the perimeter.

3. The system as in claim 2, wherein said indented portion includes a first indentation with said connectors thereon, and a second indentation which is indented by a thickness of the retention plate.

4. The system as in claim 3, wherein said retention plate includes first and second screw portions thereon, which screw into corresponding portions in said chassis.

5. The system as in claim 1, wherein said connectors are DVI connectors, said connector couplers are DVI couplers, and said indented portion is indented by a thickness of the DVI couplers.

6. The system as in claim 1, wherein said connectors include connector portions and screw portions which are intended to receive screws therein, and said plate fits around said connector portions leaving a space there around, and fits more tightly around the screw portions.

7. The system as in claim 1, further comprising a circuit board in said chassis, said circuit board connected to said at least one connector mounted on the indented portion.

8. The system as in claim 7, wherein said circuit board carries out a splitting function for the connectors.

9. The system as in claim 7, wherein said circuit board provides a media output to the connectors.

10. A method of protecting a connector, comprising:
forming a box with an outer perimeter, having a first surface defining a straight outer edge, and an indented portion which is indented relative to the outer edge, said indented portion having a flat surface with multiple connectors thereon;
mounting multiple connector couplers on said multiple connectors, respectively, each said connector coupler having a first end connected to one of said connectors, and each connector coupler having a second end having a connector extending in an opposite direction from said first end; and
mounting a retention plate, formed of a flat surface, with at least one opening in said flat surface which opening is shaped to surround an outer surface of said second end of said connector coupler, and said retention plate having surfaces that hold said connector coupler within said at least one opening, said retention plate connected to said first surface of said chassis and mounted at a location that forms a flat surface relative to said first surface.

11. The method as in claim 10, wherein said indented portion includes a first indentation with said connectors thereon, and a second indentation which is indented by a thickness of the retention plate.

12. The method as in claim 11, wherein said retention plate includes first and second screw portions thereon, which screw into corresponding portions in said chassis.

13. The method as in claim 10, wherein said connectors are DVI connectors, said connector couplers are DVI couplers, and said indented portion is indented by a thickness of the DVI couplers.

14. The method as in claim 10, wherein said second end of said connector couplers include connector portions and portions which are intended to receive screws therein, and said retention plate fits around said connector portions on said second end of said connector couplers, leaving a space around the connector portions.

15. The method as in claim 10, further comprising connecting a circuit board in said chassis to said at least one connector mounted on the indented portion.

16. The method as in claim 15, wherein said circuit board carries out a splitting function for the connectors.
